(19) United States
(12) Patent Application Publication
(10) Pub. No.: US 2025/0116757 A1
(43) Pub. Date: Apr. 10, 2025

(54) MOBILE, SELF-PROPELLED DEVICE

(71) Applicant: BSH Hausgeräte GmbH, München (DE)

(72) Inventors: Markus MOELTER, Hollstadt (DE); Frank SCHNITZER, Bad Neustadt (DE); Kristina DANIEL, Bad Neustadt (DE)

(21) Appl. No.: 18/729,262

(22) PCT Filed: Jan. 13, 2023
(86) PCT No.: PCT/EP2023/050742

§ 371 Date: Jul. 16, 2024

(30) Foreign Application Priority Data
Jan. 27, 2022 (DE) 10 2022 200 929.0

(51) Int. Cl. G01S 7/481; A47L 9/00; A47L 11/24; A47L 11/28; A47L 11/40; G01S 7/497; G01S 17/931

(52) U.S. Cl. CPC G01S 7/4813; A47L 9/009; A47L 11/24; A47L 11/28; A47L 11/4011; A47L 11/4061; G01S 7/497; G01S 17/931; A47L 2201/04

(57) ABSTRACT

A mobile, self-propelled device, and a method operating a device, with a device housing and a detection facility. The detection facility is configured to rotate about an axis of rotation relative to the device housing. A cover is arranged above the detection device and is supported by a plurality of web elements. The web elements mutually differ in in terms of design and/or position relative to the detection device. The device can be configured as a floor cleaning device for autonomously treating floor surfaces, such as a vacuuming and/or sweeping and/or mopping robot.

The invention relates to a mobile, self-propelled device, in particular a floor cleaning device for autonomously treating floor surfaces, such as a vacuuming and/or sweeping and/or mopping robot, which has a device housing and a detection facility. The invention further relates to a method for autonomously treating floor surfaces by means of such a mobile, self-propelled device.

Mobile, self-propelled devices, such as for example vacuuming robots, have the task of autonomously cleaning a floor surface in order to relieve a user of work. Frequently, such devices have systematic navigation, whereby the device can be localized and positioned in its environment. In order to ensure an autonomous and efficient cleaning of the floor surface, camera systems or lighting-independent laser-based sensors are frequently used in vacuuming robots for mapping their environment and for identifying obstacles. Laser-based sensors are generally mounted on an upper face of the vacuuming robot, they rotate about a fixed axis and record measurement values in a horizontal plane.

For error-free localization it is necessary that the position and orientation of the laser-based sensor relative to the device housing of the mobile self-propelled device are known. Moreover, it is necessary for the laser-based sensor to know the direction in which a measuring beam is oriented relative to its environment in order to add this information to the measured distance. A distance measurement without correct directional information can disadvantageously lead to the mobile self-propelled device not being localized or being incorrectly localized and/or that faulty environment maps are created. Thus, over the entire service life of the mobile self-propelled device it is advantageous for the laser-based sensor to ensure the orientation thereof or to be able to determine a change in the orientation thereof.

Generally, the laser-based sensors are calibrated once during production and then maintain these values over their remaining service life.

Properties of the laser-based sensor, however, can deviate over the service life from the values calibrated during production, due to the wear or distortion of components, due to assembly errors, or the like. This can relate, amongst other things, to the orientation of the laser-based sensor per se, in particular relative to the position thereof in the device housing. Moreover, this can result in deviations in the rotation parameters of the laser-based sensor, for example in the rotational speed of the motor of the laser-based sensor, whereby measuring beams can no longer be assigned to the correct direction.

Frequently, for the navigation, mobile, self-propelled devices comprise a LIDAR sensor which is arranged on an upper face of the device housing, which rotates by 360° and which scans a horizontal plane just above the upper face of the mobile self-propelled device. For protecting the LIDAR sensor, for example from falling objects, and for protecting against collisions with items of furniture, it is possible to arrange covers, for example lids, over the LIDAR sensor. These covers are generally borne by web elements. Where the web elements are arranged, the LIDAR sensor cannot determine distance values relative to the environment since measuring laser beams are blocked by the web elements. So-called blind spots are produced in the measuring range of the LIDAR sensor.

The web elements are conventionally identical in terms of their configuration and in each case fastened at the same spacings from one another on the cover. The opening angles between the web elements are thus substantially identical. This identical design and identical distribution of the web elements disadvantageously provides an ambiguous result when determining the orientation, whereby an unambiguous determination of the orientation is not possible.

It is the object of the present invention to provide a mobile, self-propelled device in which the orientation of the detection facility in the device housing can be monitored and recalibrated over the entire service life of the mobile, self-propelled device in order always to be able to obtain the best possible directional information for the measurement values of the detection facility.

This object is achieved by a mobile, self-propelled device having the features of claim 1 and by a method for operating a mobile, self-propelled device having the features of claim 10. Advantageous embodiments and developments form the subject matter of the dependent claims.

According to the invention, a mobile, self-propelled device, in particular a floor cleaning device for autonomously treating floor surfaces, such as a vacuuming and/or sweeping and/or mopping and/or lawn mowing robot, has a device housing and a detection facility. The detection facility is configured to rotate about an axis of rotation relative to the device housing. A cover is arranged above the detection facility and is supported by a plurality of web elements. The web elements differ in each case in terms of their design and/or position relative to the detection facility.

According to the invention, in particular, the orientation of the detection facility on the device housing is determined and monitored by the use of measuring beams which are blocked by the web elements of the cover. The position of the web elements around the detection facility and/or the design thereof are selected such that the orientation of the detection facility can be determined with optimal and/or the greatest possible accuracy. The number of measuring beams which are blocked by the web elements, and thus do not deliver a valid distance measurement value, or only a very small distance measurement value, produce reliable information regarding the direction of the detection facility relative to the device housing and to the speed thereof. This produces information not only in the case of a full revolution of the detection facility, but also in the case of a rotation in partial sections, whereby for example in the event of motors running unevenly it is possible to reduce errors and, in particular, identify errors.

The detection facility scans the horizontal plane just above the mobile self-propelled device. Preferably, to this end the detection facility rotates about a Z-axis with a 360° rotation. Laser beams which are used for a distance measurement are preferably always emitted at the same intervals. A direction relative to the device orientation can be clearly assigned to each measuring beam and thus also to each distance measurement value.

In the case of a motor rotating evenly, measuring beams are produced at uniform angular spacings. The measurement values of the detection facility, the accuracy of the environment map created and/or the accuracy of the localization are influenced by a motor rotating slowly or rapidly and which has electrical and/or mechanical properties which have changed over the service life, a detection facility rotating unevenly due to wear and/or friction, for example, or a detection facility which is no longer optimally oriented due to assembly errors or distorted components.

The orientation in which the detection facility is installed, or the directions in which the measuring beams running between the blocked measuring beams run, can be inferred from the evaluation of the measuring beams of the detection facility which are blocked by the web elements. The rotational speed of the detection facility can be inferred by taking into account the (system) time at which the individual measurements are carried out. Thus it is possible, with the aid of the variable configuration or design (geometric shape) and/or position of the web elements, to identify a speed of the detection facility varying over one revolution.

A mobile, self-propelled device is understood to mean, in particular, a floor cleaning device, for example a cleaning device or lawn mowing device, which in particular autonomously treats floor surfaces or lawn surfaces in the household sector. These include, amongst other things, vacuuming and/or sweeping and/or mopping robots, such as for example vacuum robots or lawn mowing robots.

During operation, these devices preferably operate (cleaning mode or lawn mowing mode) without user intervention, or with as little user intervention as possible. For example, the device travels automatically into a predetermined space in order to treat the floor according to a predetermined and programmed method strategy.

A device housing is understood to mean, in particular, the outer housing of the device, such that the device is outwardly sealed. Thus the inner workings of the device are located in the interior of the device housing. The detection facility protrudes over the device housing, for example in a vertical or perpendicular direction, in particular in the Z-direction. For example, the detection facility is arranged on an upper face in a central region of the device housing.

A detection facility is understood to mean any facility which is suitable for detecting obstacles, preferably in a reliable manner. This facility is preferably sensor-based, laser-based and/or camera-based. Preferably, the detection facility is a LIDAR sensor and/or a laser tower which senses or scans its environment in a horizontal plane with a 360° rotation. In particular, measuring beams, in particular laser beams, which are used for a distance measurement are output at uniform intervals by the detection facility. The rotation of the detection facility takes place about an axis of rotation, in particular about a vertical axis, relative to the device housing and is carried out by a motor.

The detection facility is protected from mechanical effects by a cover on an upper face. A cover, in particular, is any shield and/or encapsulation which is suitable for keeping mechanical forces away from the detection facility or for shielding the detection facility therefrom.

The cover is supported by a plurality of web elements. Web elements are understood to mean, in particular, any elements which are suitable for holding, supporting and/or fastening the cover to the region provided therefor. For example, the web elements are support elements and/or support legs. The web elements, in particular, have different configurations/designs (geometric shapes) and/or positions from one another relative to the detection facility. For example, the web elements vary in terms of their width relative to one another. Opening angles relative to the axis of rotation of the detection facility and thus relative to the detection facility are formed between the individual web elements. The opening angles between the individual web elements are preferably configured in each case to be of different sizes. The web elements are thus arranged at different (angular) spacings from one another.

A horizontal plane is understood to mean, in particular, any plane which runs parallel to a floor surface and in a horizontal and/or horizontally extending direction.

In particular, the horizontal plane runs parallel to the upper face of the device housing. Preferably, the horizontal plane is located at a short distance from, i.e. just above, the upper face of the device housing.

Obstacles are understood to mean any objects and/or items which are arranged in a floor treatment region, for example lying or standing there, and influence, in particular hinder and/or interrupt, the treatment by the mobile self-propelled device, such as for example furniture, walls, curtains, carpets, and the like.

A floor treatment region is understood to mean any spatial region which is provided for treating, in particular cleaning. This can be, for example, an individual (living) space or an entire apartment. This can also be understood to mean simply regions of a (living) space or an apartment which are provided for cleaning.

Preferably, the mobile, self-propelled device carries out an exploratory pass in the dedicated floor treatment region for creating an environment map. An exploratory pass is understood to mean, in particular, a reconnaissance pass which is suitable for obtaining information about a floor area to be treated relative to obstacles, room layout, and the like. The purpose of an exploratory pass is, in particular, to be able to estimate and/or depict conditions of the floor treatment region to be treated.

After the exploratory pass, the mobile, self-propelled device knows its environment and can forward this to the user in the form of an environment map, for example in an app on a mobile device. The detected obstacles are preferably displayed in the environment map.

An environment map is to be understood to mean, in particular, any map which is suitable for depicting the environment of the floor treatment region with all of its obstacles. For example, the environment map indicates in a schematic manner the floor treatment region with the obstacles and walls contained therein.

The environment map with the obstacles is preferably depicted in the app on a portable additional device. This serves, in particular, for visualizing possible interaction for the user.

In the present case, an additional device is understood to mean, in particular, any device which is portable by a user and which is arranged outside the mobile self-propelled device, in particular differentiated from the mobile self-propelled device, and is suitable for the display, provision, communication and/or transmission of data, such as for example a mobile telephone, a smartphone, a tablet and/or a computer or laptop.

In particular an app, for example a cleaning app, is installed on the portable additional device, the app serving for the communication of the mobile self-propelled device with the additional device and, in particular, permitting a visualization of the floor treatment region, i.e. of the living space to be cleaned or the living area to be cleaned. The app preferably shows the user the region to be cleaned as an environment map and any obstacles and operating or cleaning options.

In an advantageous embodiment, opening angles of different sizes relative to the axis of rotation are configured in each case between the web elements. A position and orientation of the detection facility relative to its environment can be determined by means of the opening angles of different sizes between the web elements of the cover. In particular, measuring beams which are output from the detection facility and blocked by the web elements are used for the determination. In particular, measuring beams of the detection facility which are blocked by the web elements are used to identify the orientation in which the detection facility is installed relative to the device housing and/or the direction in which the measuring beams running between the blocked measuring beams are facing.

In a further advantageous embodiment, the web elements are arranged in relation to one another with an offset to a multiple of the angular spacings between the measuring beams emitted by the detection facility. If the web elements are positioned at spacings which correspond to a multiple of the angular spacings between the measuring beams, the accuracy of the orientation of the detection facility is only in the range of such an angle. If the web elements are distributed at an offset which corresponds to a (fractional) part of this angle, the orientation of the detection facility can be advantageously determined in an improved manner. For example, three web elements can be designed with an opening angle of φ1=100.33°, φ2=120.33° and φ3=139.33° in order to improve the accuracy of the orientation angle to ⅓°. This accuracy can be further improved with further web elements, wherein this accuracy depends on the smallest common denominator of the selected opening angles.

In a further advantageous embodiment, errors in the detection facility can be determined with the aid of the measuring beams. In particular, the errors are a detection facility not rotating at the intended speed, a detection facility not optimally oriented and/or a worn detection facility. Advantageously, it is possible to determine a motor of the detection facility rotating too slowly or too rapidly, i.e. in particular electrical or mechanical properties which have changed over the service life, a detection facility rotating unevenly due to wear or friction, or a detection facility not optimally oriented due to assembly errors or distorted components.

In a further advantageous embodiment, detected values of the measuring beams are compared with predetermined values for determining errors. In particular, the determination of the orientation can be based on the measurement values of a previous revolution or a history of past and current measurements. A calibration of the detection facility is undertaken as soon as new measurement values are present or when the determined measurement values exceed a predetermined limit value. Moreover, error cases can be advantageously detected when predefined values are exceeded or fallen below by a specific (minimum) value.

Measurement values which are assigned to a web element are, in particular, not used for the navigation algorithms.

In a further advantageous embodiment, the web elements in each case have a different width. As a result, advantageously the determination of the orientation angle of the detection facility can be further improved. The width is adapted to the angular spacing between adjacent measuring beams. A width which corresponds to a multiple of 1° permits an accuracy of 1° with an angular spacing of 1° between adjacent measuring beams. A width of, for example, 1.5° determines the accuracy to approximately 0.5° in otherwise identical conditions. The web elements of different widths block a different number of measuring beams of the detection facility and thus advantageously can further improve, optimize and/or multiply the overall accuracy.

In a further advantageous embodiment, the web elements are configured to be extendable or retractable. For example, a cover with optical windows is used, whereby the visible range of the detection facility is maximized. The web elements are moved into the visible range of the detection facility, as required, in particular for the purposes of calibration or monitoring the detection facility. For example, the web elements are flaps which can be extended by a motor. In this case, a continuous monitoring and calibration is not ensured, but only a needs-based monitoring and calibration which has recurring and only briefly disruptive influences.

Advantageously, the mobile, self-propelled device according to the invention continuously permits reliable measured data and consequently improved mapping data of the environment and navigation results. In particular, the accuracy of the determination of the orientation is increased and improved in comparison with uniformly distributed web elements of the cover. A measurement is also possible locally, in particular between individual web elements, since the web elements which are present can be clearly identified due to their unique design. The direction of the measuring beams located between the web elements can also be determined in an improved manner, whereby the overall navigation is improved, even in the case of detection facilities rotating unevenly. In particular, component tolerances and component wear can be detected and compensated over many years. Error cases of the detection facility can also be simply and rapidly detected. This is implemented without additional sensors which monitor the orientation of the detection facility and the rotation thereof, such as for example an encoder, absolute encoder or the like. The assembly is also simplified by the invention since an installation direction does not have to be observed when assembled during production. A replacement of the detection facility by customer services can also be facilitated, since an additional calibration routine does not have to be carried out.

The invention further relates to a method for operating a mobile, self-propelled device, wherein the detection facility is calibrated and/or monitored for errors using its measuring beams, by a position and orientation of the detection facility relative to its environment being determined by means of the variable configuration and/or position of the web elements.

Any features, designs and embodiments and advantages relating to the method also apply in connection with the mobile, self-propelled device according to the invention and vice versa.

The invention is explained in more detail with reference to the following embodiments of the invention which merely represent examples, in which:

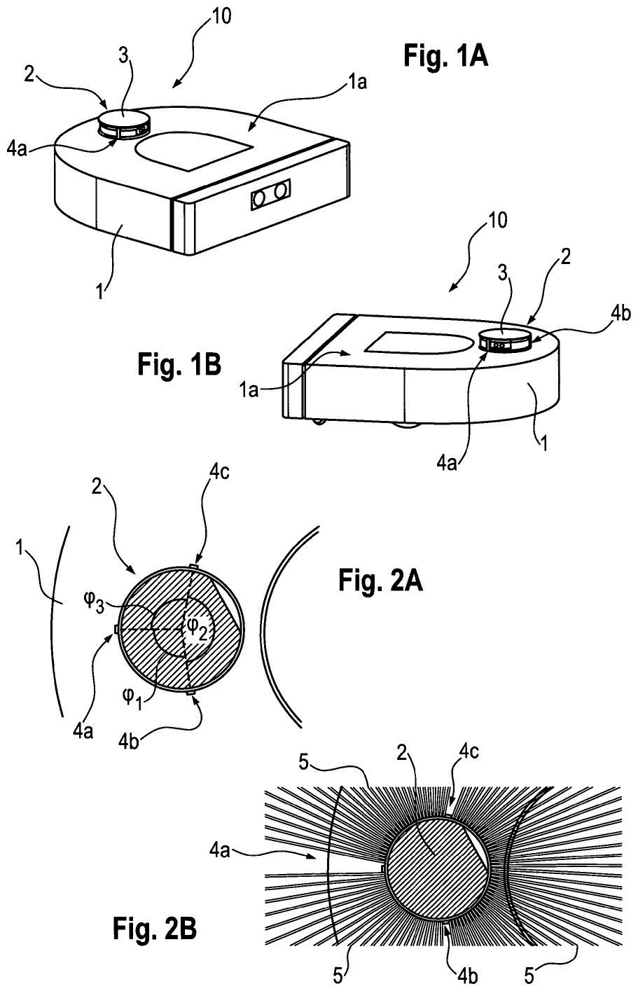

FIGS. 1A, 1B: show in each case a schematic view of an exemplary embodiment according to the invention of a mobile, self-propelled device,

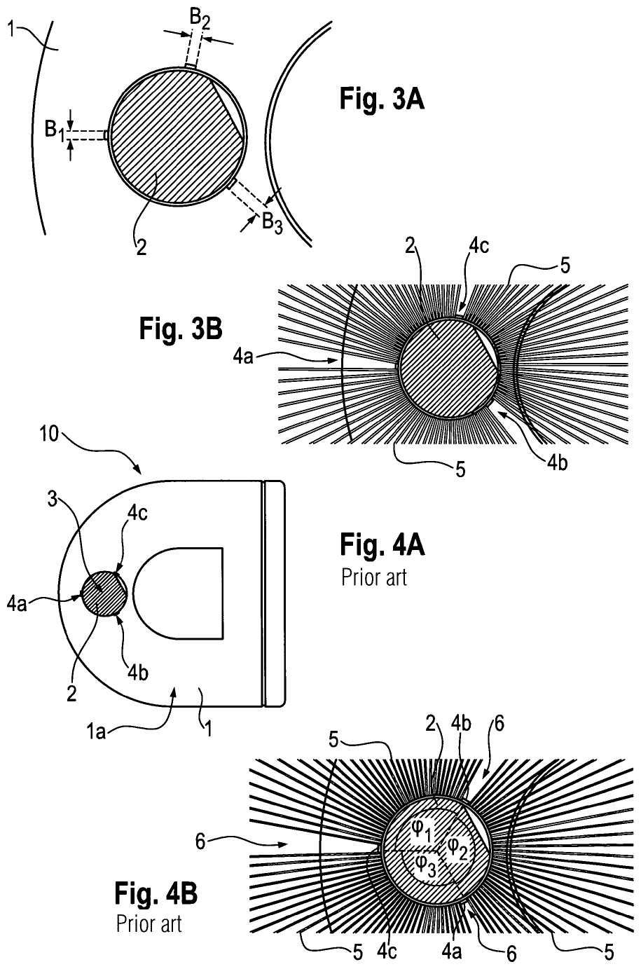

FIGS. 2A, 3A: show in each case a schematic plan view of a detection facility of an exemplary embodiment according to the invention of a mobile, self-propelled device,

FIGS. 2B, 3B: show in each case a schematic plan view of a detection facility of an exemplary embodiment according to the invention of a mobile, self-propelled device during operation,

FIGS. 4A, 4B: show in each case a schematic view of a mobile, self-propelled device according to the prior art, and

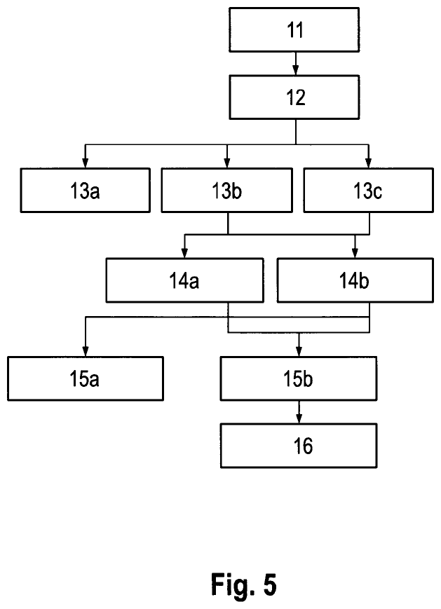

FIG. 5 shows a flow diagram relating to an exemplary embodiment of a method according to the invention for operating a mobile, self-propelled device.

A conventional mobile, self-propelled device, in particular a vacuuming robot 10, which has a device housing 1 and a detection facility, is shown in a plan view in FIG. 4A. The detection facility in the present case is a laser tower, in particular a LIDAR sensor 2 (light detection and ranging-sensor). In order to achieve a cleaning result which is as optimal as possible, the LIDAR sensor 2 is arranged on an upper face 1a of the device housing 1. Specifically, the LIDAR sensor 2 is not located exactly in the center of the upper face. However, the LIDAR sensor 2 is arranged in a central region of the upper face.

The LIDAR sensor 2 comprises a laser sensor which is provided to output laser radiation. In particular, during operation the laser sensor rotates about its perpendicular or vertical axis (in FIG. 4A this axis extends centrally in the LIDAR sensor 2 vertically into the drawing plane) and always records distance measurement values at the same intervals. A direction relative to the orientation of the vacuuming robot can be clearly assigned to each measuring beam and thus each distance measurement value. An evaluation unit which is arranged in the device housing 1 is used to this end. The LIDAR sensor 2 which is present scans, in particular, a horizontal plane (in FIG. 4A this horizontal plane is in the drawing plane), preferably over a 360° angle, which is located just above the upper face 1a of the device housing 1.

A cover 3 in the form of a lid is arranged above the LIDAR sensor 2 for protecting the LIDAR sensor 2 from falling objects and from collisions with items of furniture or other obstacles. This cover 3 is borne by web elements 4a, 4b, 4c. In particular, three web elements 4a, 4b, 4c are used. Where the web elements are arranged, no distance values of the environment can be determined by the LIDAR sensor 2, since the measuring laser beams 5 are blocked by the web elements 4a, 4b, 4c. So-called blind spots 6 are produced in the measuring range of the LIDAR sensor 2 (see FIG. 4B).

The web elements 4a, 4b, 4c are fastened to the cover 3 in each case at the same spacings from one another. The opening angles φ1, φ2 and φ3 between the web elements are substantially identical, i.e. φ1=φ2=φ3. Due to this equal distribution of the web elements 4a, 4b, 4c, a determination of the orientation of the LIDAR sensor 2 relative to the device housing 1 is not possible in a definitive manner.

In order to permit such an orientation of the LIDAR sensor 2 on the vacuuming robot 10, an unevenly distributed arrangement of the web elements 4a, 4b, 4c is used, individual opening angles being able to be identified thereby, as is described in connection with the following figures.

FIGS. 1A, 1B show schematic views of a vacuuming robot 10 according to the invention which comprises a device housing 1 and a LIDAR sensor 2 on an upper face 1a of the device housing. The LIDAR sensor 2 is equipped with a cover 3 which protects the LIDAR sensor 2 from impacts and collisions. The cover 3 is borne by three web elements 4a, 4b, 4c.

The LIDAR sensor 2 scans its environment during operation with a 360° rotation. Measuring beams, in particular laser beams, which are used for a distance measurement are output at short intervals. The web elements 4a, 4b, 4c are designed such that they block predetermined measuring beams in a targeted manner. The number of measuring beams which are blocked by a web element 4a, 4b, 4c and thus do not deliver a distance measurement value, or only a very small distance measurement value, provides information about the direction of the LIDAR sensor 2 relative to the device housing 1 and the rotational speed thereof, in particular not only over a complete revolution but also in partial sections of the rotation, which results in a reduction of errors of the LIDAR sensor 2.

The web elements 4a, 4b, 4c are distributed around the laser of the LIDAR sensor 2 at an offset which corresponds to a (fractional) part of the angle between the measuring beams. This is shown, in particular, in connection with FIGS. 2A, 2B. According to the invention, the three web elements 4a, 4b, 4c are arranged at an opening angle φ1≠φ3 and φ2≠φ3 relative to one another. For example, φ1=120.33°, φ2=139.33° and φ3=100.33°.

If an evaluation takes place as to which measuring beams 5 are blocked by the web elements 4a, 4b, 4c, it is possible to determine the orientation in which the LIDAR sensor 2 is installed and/or the directions in which the measuring beams 5 running between the blocked beams lead. The accuracy of the orientation angle of the LIDAR sensor 2 can be advantageously improved with angular spacings offset in this manner. The rotational speed of the LIDAR sensor can also be determined by taking into account the (system) time at which the respective measurements are carried out. Moreover, a speed of the LIDAR sensor 2 varying over one revolution can be detected with the aid of the opening angles φ1, φ2 and φ3 of different sizes between the web elements 4a, 4b, 4c.

In particular, the measurement values of the LIDAR sensor 2, the accuracy of the environment map created and the accuracy of the localization are influenced by a motor rotating too slowly or too rapidly with electrical and/or mechanical properties which have changed over the service life, a LIDAR sensor 2 rotating unevenly due to wear or friction, or a LIDAR sensor 2 no longer optimally aligned due to assembly errors or distorted parts. Advantageously, the orientation of the LIDAR sensor 2 on the device housing 1 can be determined and monitored by the evaluation of the measuring beams 5 of the LIDAR sensor. A regular and reliable calibration of the LIDAR sensor can be advantageously achieved.

The determination of the orientation can be based on the measurement values of one revolution or on a history of past and current measurements of the LIDAR sensor 2. A calibration of the LIDAR sensor 2 can be undertaken as soon as new values are present and/or when the determined values exceed a predetermined and/or fixed limit value. Furthermore, error cases can be detected when the usual or predefined values are exceeded or fallen below by a fixed value. Measurement values which are assigned to a web element 4a, 4b, 4c are not used for the navigation algorithms.

A further improvement in the determination of the orientation angle of the LIDAR sensor 2 can be implemented by a targeted width of the web elements 4a, 4b, 4c as shown in FIGS. 3A, 3B. The choice of width of the individual web elements 4a, 4b, 4c is preferably based on the angular spacing between adjacent measuring beams 5. A width of, for example, 1.5° permits a measuring accuracy of specifically 0.5° with an angular spacing of 1° between adjacent measuring beams. The web elements 4a, 4b, 4c of different widths block different numbers of measuring beams 5 and thus multiply the overall accuracy. The following relationship of the width of the individual web elements 4a, 4b, 4c applies in an ideal case: B₁≠B₂, B₁≠B₃ and B₂≠B₃.

A basic flow diagram for the present invention is shown in FIG. 5. In step 11, the individual LIDAR measurement values are detected. It is then checked whether these measurement values are within the web element regions, or not (step 12). If the measurement values are outside the web elements, the measurement values are fed into the navigation of the mobile, self-propelled device or the respective measurement values are discarded (step 13a). It is also determined how many adjacent measurement values are located between two web elements (step 13b). If the measurement values are within the web elements, it is determined in step 13c how many adjacent measurement values can be assigned to a web element. The rotational speed between the web elements can be determined by the adjacent measurement values between the web elements and by those measurement values assigned to the web elements (step 14a). The overall orientation of the LIDAR sensor can also be derived from the known geometry of the web elements (step 14b). Thus it can then be checked whether an error case of the LIDAR sensor is present (step 15a). The direction of the individual measuring beams of the LIDAR sensor can also be determined (step 15b). Finally, the orientation values can be used for creating the environment map and localization (step 16).

1-10. (canceled)

11. A mobile, self-propelled device, comprising:
a device housing;
a detection facility configured to rotate about an axis of rotation relative to said device housing; and
a cover arranged above the detection facility and being supported by a plurality of web elements;
said web elements having mutually different shapes and/or position relative to the detection facility.

12. The mobile, self-propelled device according to claim 11, further comprising:
opening angles relative to the axis of rotation between each of said web elements;
said opening angles having mutually different sizes; and
said detection facility being configured to determine a position and/or orientation of the detection facility relative to its environment based on the opening angles of different sizes.

13. The mobile, self-propelled device according to claim 12, wherein the position and/or orientation of the detection facility is configured to be determined based on measuring beams output from the detection facility and blocked by the web elements.

14. The mobile, self-propelled device according to claim 13, wherein said detection facility is configured to determined errors based on the measuring beams.

15. The mobile, self-propelled device according to claim 14, wherein the errors to be determined by the detection facility are at least one of said detection facility not rotating at the dedicated speed, said detection facility not optimally oriented and said detection facility being worn.

16. The mobile, self-propelled device according to claim 14, wherein said detection facility is configured to compare detected values of the measuring beams with predetermined values for determining errors.

17. The mobile, self-propelled device according to claim 11, wherein said web elements have mutually different widths.

18. The mobile, self-propelled device according to claim 13, wherein the web elements are arranged relative to one another with an offset to a multiple of an angular spacings between the measuring beams emitted by the detection facility.

19. The mobile, self-propelled device according to claim 11, wherein the web elements are configured to be extendable or retractable.

20. The mobile, self-propelled device according to claim 11, wherein the device is a floor cleaning device for autonomously treating floor surfaces.

21. The mobile, self-propelled device according to claim 20, wherein the floor cleaning device is a vacuuming, sweeping, and/or mopping robot.

22. A method for operating a mobile, self-propelled device according to claim 11, the method comprising calibrating and/or monitoring the detection facility for errors based on measuring beams of the detection facility by determining a position and orientation of the detection facility relative to its environment being determined based on variable configuration and/or position of the web elements.
